(19) United States
(12) Patent Application Publication
(10) Pub. No.: US 2005/0282953 A1
(43) Pub. Date: Dec. 22, 2005

(54) Hydrophobic coating composition

(75) Inventors: William H. Simendinger III, Raleigh, NC (US); David William Garrett, Raleigh, NC (US)

Correspondence Address: MYERS BIGEL SIBLEY & SAJOVEC, PO BOX 37428, RALEIGH, NC, 27627, US

(73) Assignee: MicroPhase Coatings, Inc.

(21) Appl. No.: 11/149,886

(22) Filed: Jun. 10, 2005

Related U.S. Application Data
(60) Provisional application No. 60/580,554, filed on Jun. 17, 2004.

(51) Int. Cl. C09B 67/00

(52) U.S. Cl. 524/502

(57) ABSTRACT

The present invention provides a durable and weatherable hydrophobic coating composition. The hydrophobic coating comprises a glassy matrix formed by crosslinking a silicone or a silane and siloxane, and a fluorinated compound. In one embodiment, the coating composition comprises a glassy matrix and a fluorinated compound, wherein the glassy matrix is formed by crosslinking a mixture of a glycidyl silane modified polyamide, an organic-modified silicone and a C₄ to C₂₀ triethoxysilane. In another embodiment, the glassy matrix is formed by crosslinking a silicone and a C₄ to C₂₀ silane.

### RELATED APPLICATIONS

This application claims priority to U.S. Provisional Application No. 60/580,554; filed on Jun. 17, 2004, the disclosure of which is incorporated herein by reference in its entirety.

### FIELD AND BACKGROUND OF THE INVENTION

The present invention relates to a hydrophobic coating composition suitable for use on a variety of substrates and surfaces. Of particular interest is the use of the composition as a coating for surfaces exposed to the weather and which are susceptible to water film formation.

For example, there is a need for hydrophobic coating compositions for articles that are exposed to weather-related water and moisture such as satellite dishes, radar dishes, radomes, other signal receivers and transmitters, windshields and rainshields. Such coating compositions must be durable but also should not adversely affect or interfere with signal transmission or reception.

### SUMMARY OF THE INVENTION

The present invention provides a durable and weatherable hydrophobic coating composition. The hydrophobic coating comprises a glassy matrix formed by crosslinking a siloxane and a silane, and a fluorinated compound. In one embodiment, the coating composition comprises a glassy matrix and a fluorinated compound, wherein the glassy matrix is formed by crosslinking a mixture of a glycidyl silane modified polyamide, an organic-modified silicone and a C₄ to C₂₀ triethoxysilane. The composition, once crosslinked, is an organically modified ethoxy/silane crosslinked composition. In another embodiment, a glassy matrix is formed by crosslinking a methyl hydrosilicone and a C₄ to C₂₀ silane.

### DETAILED DESCRIPTION OF THE INVENTION

As discussed above, the hydrophobic coating comprises a glassy matrix and a fluorinated compound. In one embodiment, the glassy matrix is formed by crosslinking a glycidyl silane modified polyamide, an organic-modified silicone and a C₄ to C₂₀ triethoxysilane. A preferred C₄-C₂₀ triethoxysilane is N-octyl triethoxysilane. The glycidyl silane modified polyamide is formed by reacting a glycidyl silane and a polyamide such as ancamide 220, a polyamide curing agent available from Air Products, Allentown, Pa. Suitable glycidyl silanes include 3-(glycidoxypropyl)trimethoxysilane, 3-(glycidoxypropyl)dimethylethoxysilane 3-(glycidoxypropyl)triethoxysilane and 3-(glycidoxypropyl)methyldimethoxysilane.

Suitable organic-modified silicones are prepared by reacting a silicone, e.g., 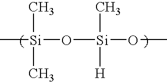
with a C₄-C₂₀ alkene such a hexadecene in the presence of a catalyst to form the organic-modified silicone, e.g.,

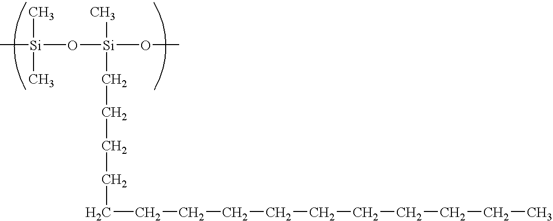

In another embodiment, the glassy matrix is formed by crosslinking a silicone and a C₄ to C₂₀ silane. Suitable silicones include methyl hydrosilicone or dimethyl hydromethylsilicone copolymers. Suitable C₄ to C₂₀ silanes include octylsilane, octadecyl silane, hexadecyl silane, and decyl silane. It is recognized that the term “octyl” silane or “hexadecyl” silane relates to a variety of silanes having octyl, hexadecyl, etc. . . . functionality. Thus, for example, octylsilane can include n-octyl triethoxysialane and octyl trichlorosilane.

Suitable fluorinated compounds include both perfluorinated and non-perfluorinated monomers and/or polymers. A preferred fluorinated compound is polytetrafluoroethylene (PTFE) Teflon® powder.

The glassy matrix is crosslinked using a titanium or tin catalyst. Suitable catalysts include, without limitation, titanium alkoxides such as titanium methoxide, titanium ethoxide, titanium isopropoxide, titanium propoxide, titanium butoxide, titanium diisopropoxide (bis 2,4-pentanedionate), titanium diisopropoxide bis(ethylacetoacetateo) titanium ethylhexoxide, and organic tin compounds such as dibutyl tin diacetate, dibutyltin dilaurate, dimethyl tin dineodecanoate, dioctyl dilauryl tin, and dibutyl butoxy chlorotin, as well as mixtures thereof.

The matrix formulation may also include additives such as fillers (e.g., fumed silica, mica, kaolin, bentonite, talc), zinc oxides, zinc phosphates, iron oxides, cellulose, pigments, corrosion inhibitors, UV light stabilizers, thixotropic agents, epoxy modifiers, UV indicators, ultra high molecular weight polyethylene powder, high, medium and low molecular weight polyethylene powder, or other additives, as will be readily apparent to those skilled in the art. Additionally, the pH can be balanced such as by adding acetic acid.

The cured hydrophobic coating composition comprises about 10 to 30 percent by weight of the glassy matrix and about 70 to 90 percent by weight of the fluorinated compound. In one embodiment, the glassy matrix comprises 1 to 10 percent total weight of the coating composition of glycidyl silane modified polyamide, 0.5 to 5 percent by total weight of the coating composition organic modified silicone and 5 to 20 percent by total weight of the coating compositions C₄-C₂₀ triethoxysilane. In another embodiment, the glassy matrix is 60 to 90 percent by total weight of the coating silicone and 1 to 40 percent by total weight of the coating C₄-C₂₀ silane.

In operation, the hydrophobic composition of the present invention can be applied by roll-coating, brush, spray coating, dipping and the like. It is preferred that the user mix the catalyst with the other components right before or substantially contemporaneously with application. The composition is preferably applied at a thickness of about 10 to 500 microns.

The hydrophobic coating composition can be applied on signal receivers including, but not limited to, antennas, radar dishes, satellite dishes and radomes. Microwave signals are significantly attenuated by atmospheric precipitation and by films on the surface of a receiver or transmitter. As bandwidths expand, commercial and private use of microwave links, e.g., hotels offering wireless Internet connections, the problem of signal attenuation caused by atmospheric precipitation has increased. Thus another aspect of the invention is a signal receiver or transmitter surface coated with the hydrophobic composition of the invention.

The present invention can also be used on laboratory vessels, vehicular surfaces, signal reflectors, architectural surfaces, outdoor furniture, household goods, kitchen articles, kitchen surfaces, bathroom articles, bathroom surfaces, signs, visual signaling devices, scanner windows, lenses, liquid crystal displays, windshields, rainshields and video displays.

The coating compositions preferably has an interfacial contact angle of >150°, often >160°, and preferably >170°. The surface energy is preferably less than 20 dynes/cm and more preferably less than 20 dynes/cm.

### EXAMPLES

The following examples are provided to afford a better understanding of the present invention to those skilled in the art. It is to be understood that the examples are intended to be illustrative only and is not intended to limit the invention in any way.

### Example 1

Part A

| Component | Grams | Weight (%) |
|---|---|---|
| Water | 2630 | 65.76 |
| UV Tracer | 1.60 | 0.040 |
| Acetic Acid | 55 | 1.37 |
| Acetone | 501 | 12.53 |
| PTFE powder | 812 | 20.30 |

Mixing
Add water and UV tracer. Stir.
Slowly add acetic acid with stirring
Slowly add PTFE dispersion with mild stirring.
Pour mix into Waring blender, add PTFE powder, and blend at low speed until powder is wet-out.

Part B

| Component | Grams | Weight (%) |
|---|---|---|
| 3-(Glycidoxypropyltrimethoxy)silane | 100.83 | 33.61 |
| n-Octyl triethoxysilane | 38.37 | 12.79 |
| Isopropyl Alcohol | 114.84 | 38.28 |
| Tin Diacetate | 22.98 | 7.66 |
| Silicone-hexadecene | 22.98 | 7.66 |

Mixing
Add the first three ingredients and stir.
Add tin diacetate and stir.
Add silane-hexadecene product and stir for 1 minute to insure homogeneity.

Part C

| Component | Grams | Weight (%) |
|---|---|---|
| 60% PTFE dispersion | 126.66 | 100 |
| in H₂O | | |

Hexadecene/Silane Copolymer Formulation

| Component | Grams | Weight (%) |
|---|---|---|
| Methyl hydrosilicone | 37.87 | 37.87 |
| Hexadecene | 47.46 | 47.46 |
| Vinyl triethoxysilane | 13.41 | 13.41 |
| 5% PT catalyst | 1.26 | 1.26 |

Mixing
Prepare in clean glassware. The catalyst can be poisoned by metals and impurities.
Add the first three ingredients and stir.
Add the catalyst, stir and cap container.
Heat container in oven for 4 hours at 140° C.
Remove from oven and allow to cool. Run FTIR spectrum and measure viscosity at 25° C.

3-(Glycidoxypropyltrimethoxysilane Formulation

| Component | Grams | Weight (%) |
|---|---|---|
| Ancamide 220 | 50 | 41.67 |
| 3-(Glycidoxypropltrimethoxy)silane | 70 | 58.33 |

Mixing
Weigh the two ingredients into a plastic beaker and stir with a stirring stick.
Heat material for 90 minutes at 90° C. Stir every 15-20 minutes.
Cool. Run FTIR spectrum and measure viscosity at 25° C.
Use immediately.
The ratio of Part A/Part B/Part C is 91.54/5.40/3.06.
The coating passes 2000 inches of rain (60 inches/hour for 34 hours), is resistant to ethanol, MEK, acetone and acid rain, is UV-resistant and resists high humidity. The definition of resistance is that a drop of water will roll off the surface at 2° incline after exposure.

### Example 2

Part A

| Component | Grams | Weight (%) |
|---|---|---|
| Water | 132.00 | 49.78 |
| UV Indicator | 0.11 | 0.04 |
| Isopropyl | 48.60 | 18.33 |
| Alcohol | | |
| Acetic Acid | 4.00 | 1.51 |
| PTFE powder | 56.00 | 20.06 |
| 60% PTFE | 27.81 | 10.46 |
| dispersion in H₂ | | |

Part B

| Component | Grams | Weight (%) |
|---|---|---|
| Methyl hydrosilicone | 20.00 | 60.75 |
| n-Octyl triethoxysilane | 10.00 | 30.37 |
| Tin Diacetate | 2.92 | 8.86 |

The ratio of Part A/Part B is 11.1/1.0.

In the specification and examples, there have been disclosed typical preferred embodiments of the invention and, although specific terms are employed, they are used in a generic and descriptive sense only and not for purposes of limitation of the scope of the invention set forth in the following claims.

1. A hydrophobic coating composition comprising:
(a) a glassy matrix formed by crosslinking a mixture of a glycidyl silane modified polyamide, an organic modified silicone and a C₄ to C₂₀ triethoxysilane, and
(b) a fluorinated compound.

2. The hydrophobic coating according to claim 1, wherein the glycidyl silane portion of the glycidyl silane modified polyamide is 3-(glycidoxypropyl)triethoxysilane.

3. The hydrophobic coating according to claim 1, wherein the composition further comprises an additive.

4. The hydrophobic coating according to claim 3, wherein the additive is selected from the group consisting of fumed silica, mica, kaolin, bentonite, talc, zinc oxides, zinc phosphates, iron oxides, cellulose, pigments, ultra high molecular weight polyethylene powder, high, medium and low molecular weight polyethylene powder.

5. The hydrophobic coating according to claim 1, wherein the glassy matrix is crosslinked using an organotitanate or tin catalyst.

6. The hydrophobic coating according to claim 1 wherein the fluorinated compound is polytetrafluoroethylene.

7. A signal receiver or transmitter coated with the hydrophobic coating composition of claim 1.

8. A hydrophobic coating composition comprising:
(a) a glassy matrix formed by crosslinking a silicone and a C₄ to C₂₀ silane; and
(b) a fluorinated compound.

9. The hydrophobic coating composition according to claim 8, wherein the silicone is methylhydrosilicone and the C₄ to C₂₀ silane is octyl silane.

10. The hydrophobic coating according to claim 8, wherein the composition further comprises an additive.

11. The hydrophobic coating according to claim 10, wherein the additive is selected from the group consisting of fumed silica, mica, kaolin, bentonite, talc, zinc oxides, zinc phosphates, iron oxides, cellulose, pigments, ultra high molecular weight polyethylene powder, high, medium and low molecular weight polyethylene powder.

12. The hydrophobic coating according to claim 8, wherein the glassy matrix is crosslinked using an organotitanate or tin catalyst.

13. The hydrophobic coating according to claim 8 wherein the fluorinated compound is polytetrafluoroethylene.

14. A signal receiver or transmitter coated with the hydrophobic coating composition of claim 8.
